(19) United States
(12) Patent Application Publication
(10) Pub. No.: US 2026/0276892 A1
(43) Pub. Date: Sep. 17, 2026

(54) TILED COLLIMATOR ARRAY

(71) Applicant: Elbit Systems Electro-optics - Elop Ltd., Rehovot (IL)

(72) Inventors: Asaf TURM, Rehovot (IL); Zeev SCHIFEER, Rehovot (IL); Leeron Hanan BRACHA, Rehovot (IL); Daniel WORMSER, Rehovot (IL); Rina COHEN, Rehovot (IL)

(73) Assignee: Elbit Systems Electro-optics - Elop Ltd., Rehovot (IL)

(21) Appl. No.: 19/168,293

(22) PCT Filed: Mar. 26, 2024
(86) PCT No.: PCT/IL2024/050310

§ 371 Date: Sep. 23, 2025

(30) Foreign Application Priority Data
Mar. 26, 2023 (IL) 301657

(51) Int. Cl. G02B 6/26; G02B 1/11; G02B 27/30

(52) U.S. Cl. CPC G02B 6/262; G02B 1/11; G02B 27/30

(57) ABSTRACT

A tiled collimator array is disclosed. The tiled collimator array includes, a plurality of endcaps each being connected to an optical fiber at a back end, wherein the endcaps are selected from hexagonal endcaps and quadrangular endcaps; and an adhesive gluing the endcaps to each other, wherein the endcaps are stacked together in a compacted structure.

### CROSS REFERENCE TO RELATED APPLICATIONS

This application is a PCT patent application which claims the benefit of priority of Israeli Patent Application No. 301657, filed Mar. 26, 2023. The contents of the above application is all incorporated by reference as if fully set forth herein in its entirety.

### FIELD OF THE INVENTION

The present invention relates generally to a collimator array. More specifically, the present invention relates to a tiled collimator array.

### BACKGROUND OF THE INVENTION

High-power laser beam is usually achieved by combining a plurality of collimated smaller laser beams. For the combining to be effective all the beams must be aligned in a compact structure. The alignment must be kept throughout the lifespan of the high-power laser, taking into account retention during temperature changes and vibrations.

In high-power laser source the power density within the fiber core becomes extremely high. Therefore, the exit end of the fiber (to free space environment) should be treated to avoid its melting-down. Accordingly, an endcap is attached to the end of the optical fiber. The endcap is a glass-block having much larger diameter than the fiber to which the fiber end is spliced. The resulting laser spot diameter at its output becomes significantly larger, this decreases power density significantly to values safe for long-term laser operation.

One known technique for achieving a coherent beam combining is known as the Tiled apertures, where a large number of collimated beams are aligned to generate desired wave-front amplitude and phase.

In order to get reasonable performance collimators should be aligned with high accuracy and stability that measures in micro-meters.

An attempt was made to overcome the above mentioned drawback by producing a monolithic collimator array that is made by splicing multiple fibers to a single glass block. One major draw-back of such glass structure, is that the process of manufacturing is not trivial and by that, the yield of such a product might be very small or some of the fiber splices might be damaged.

Therefore, there is a need for tiled laser collimator array for high-power laser that will minimize the retention during temperature changes and vibrations, while keeping the array of fibers and endcaps aligned.

### SUMMARY OF THE INVENTION

Some aspects of the invention are directed to a tiled collimator array, comprising: a plurality of endcaps each being connected to an optical fiber at a back end, wherein the endcaps are selected from hexagonal endcaps and quadrangular endcaps; and an adhesive gluing the endcaps to each other, wherein the endcaps are stacked together in a compacted structure.

In some embodiments, the adhesive is selected from, a transparent adhesive, and optical adhesive. In some embodiments, a thickness of the adhesive is between 0.0001 to 0.1 of the diameter of the inscribed circle of the endcaps cross-section. In some embodiments, the optical fiber is spliced to the back end such that the optical axis of the fiber merges with the optical axis of the endcap.

In some embodiments, each endcap comprises a front lens at a second end. In some embodiments, the tiled collimator array further comprises Diffractive Optical Elements (DOE) located ahead of the front lenses on an optical axis of the tiled collimator array. In some embodiments, the length of the endcaps is equal to or shorter than the focal length of the lens.

In some embodiments, all the optical fibers are aligned at the same polarization. In some embodiments, a length of each endcap is determined based on the wavelength, the numerical aperture (NA) of the fiber, and a desired beam diameter. In some embodiments, a diameter of circumscribed circle of each endcap is determined based on the desired beam diameter and internal reflectance inside the endcap. In some embodiments, a diameter of the optical fiber core is between 5 to 50 μm. In some embodiments, side facets of each endcap are coated with antireflective coating.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are illustrations of a perspective and cross-section views in a tiled collimator array according to some embodiments of the invention;

FIG. 1C is an illustration of an endcap connected to an optical fiber according to some embodiments of the invention; FIG. 1D is an illustration of another endcap connected to an optical fiber according to some embodiments of the invention;

FIG. 1E is an illustration of the reflected light from the surface of the lens back into the endcap, according to some embodiments of the invention;

FIGS. 2A and 2B are illustrations of perspective views of two tiled collimator arrays comprising hexagonal endcaps according to some embodiments of the invention; and

FIG. 3 is an illustration of a perspective view of a tiled collimator array comprising square endcaps according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting the invention described herein. Scope of the invention is thus indicated by the appended claims, rather than by the foregoing description, and all changes that come within the meaning and range of equivalency of the claims are therefore intended to be embraced therein.

Some aspects of the invention are directed to a tiled collimator array for high-power lasers (e.g., a laser having power higher than 1 kW). High-power lasers that comprise the collimation of multiple aligned laser beams require a special structure. Such a structure may include an array of endcaps each being connected to an optical fiber and adhesive gluing the endcaps to each other. The endcaps are designed to reduce the power density from several MW/cm² by at least two orders of magnitude (e.g., three orders or more), for example, to several kW/cm².

During operation, internal reflections in the endcap may cause light to travel to the surrounding mechanics and may cause heat that elevates the temperature of the adhesive on the surface of the endcaps, therefore, may cause movements, due to thermal expansion of the glue and/or surrounding mechanics. The absorption of the glass can also cause heating of the endcap. Reflections from other optical elements (e.g. collimation lens), can also heat the endcap and its surroundings.

Therefore, the array of endcaps was selected from hexagonal endcaps or quadrangular endcaps, triangle endcaps, rhombus endcaps and the like, glued together at a compacted array. As should be understood by one skilled in the art endcaps with other polygonal cross sections are also in the scope of the invention.

In some embodiments, in order to minimize the reflection, the adhesive may be selected to be a transparent optical adhesive.

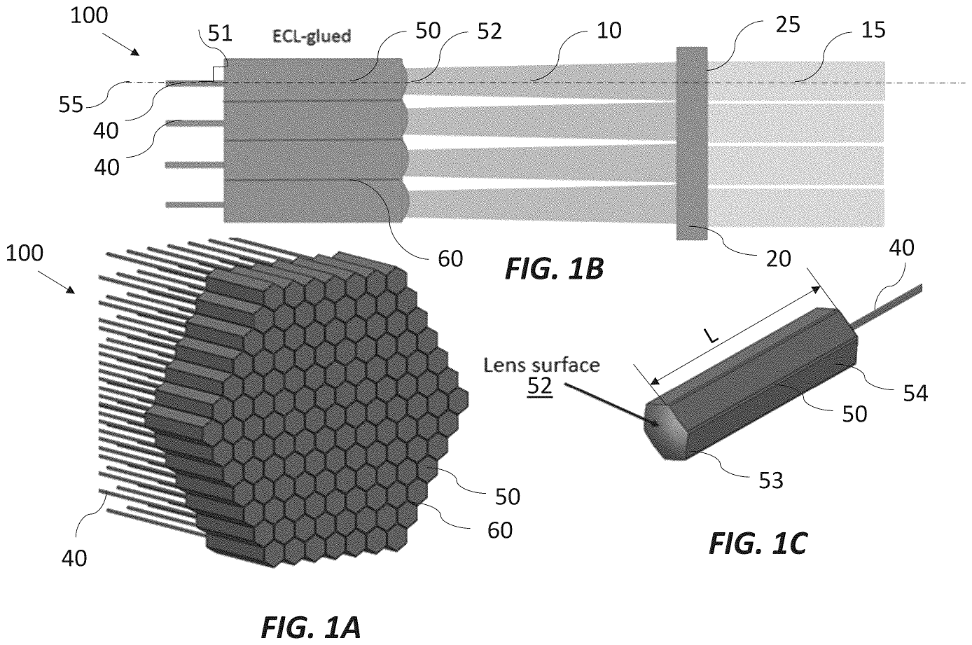

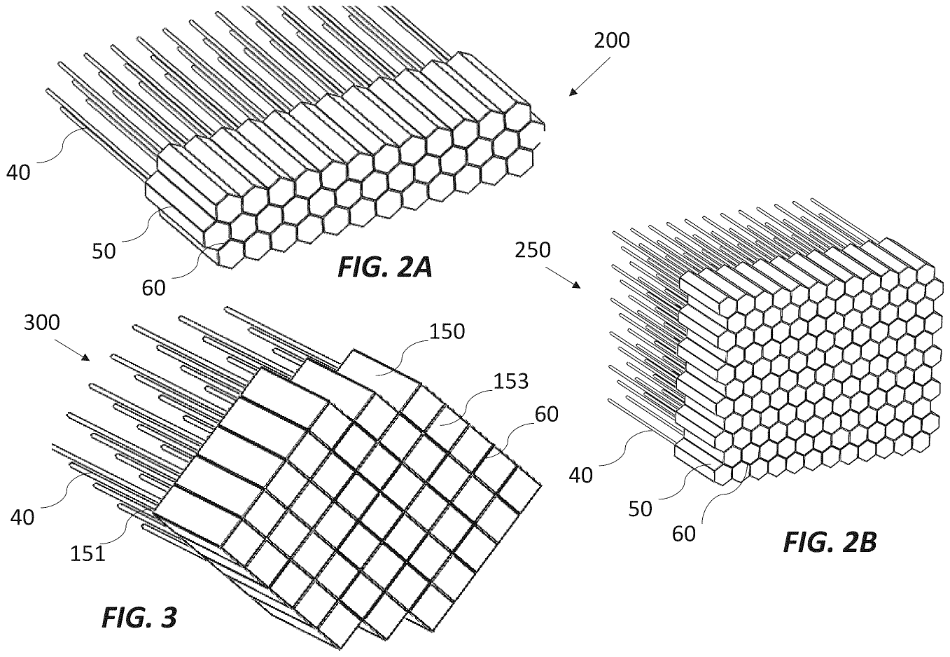

Reference is now made to FIGS. 1A and 1B which are illustrations of a perspective and cross-section views in a tiled collimator array according to some embodiments of the invention. A tiled collimator array 100 may include a plurality of endcaps 50 each being connected to an optical fiber 40 at a back end 51, wherein endcaps 50 are selected in these embodiments from hexagonal endcaps (as illustrated) and quadrangular endcaps (illustrated and discussed with respect to FIG. 3). In some embodiments, endcaps 50 are stacked together in a compacted structure, for example, the hive-like structure illustrated in FIGS. 1A and 1B, and glued by adhesive 60.

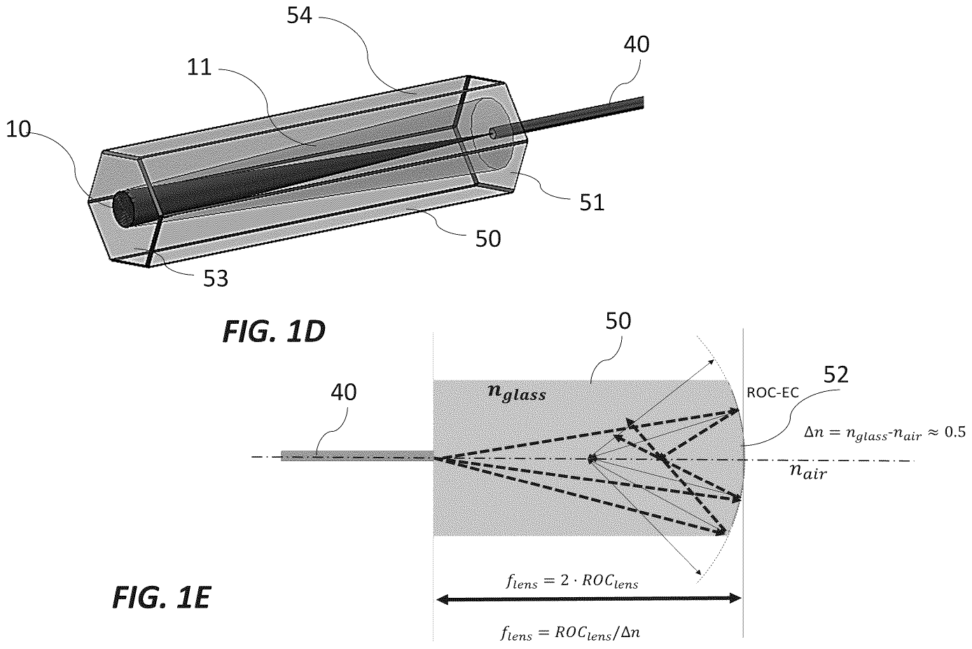

As should be understood by the one skill in the art the hive-like array illustrated in FIGS. 1A and 1B, the box-like array illustrated in FIGS. 2A and 2B, and the array illustrated in FIG. 3 are given as examples only and the invention is not limited to these specific examples. Any compacted array of hexagonal endcaps or quadrangular endcaps or endcaps having any other polygonal cross sections is within the scope of the invention.

Furthermore, the invention is not limited to a specific number of endcaps to be included in each array. which can be any number greater than 2, for example, 5, 10, 15, 20, 30, 40, 50, 100, 125, 150, 175, 200, 300, 400, 500, and any number in between.

In some embodiments, back end 51 of endcap 50 may be a plane perpendicular to the longitudinal/optical axis 55 of endcap 50, as illustrated in FIGS. 1B and 1D. In some embodiments, the perpendicularity may vary between 0 to 0.5. In some embodiments, optical fiber 40 is spliced to back end 51 such that the optical axis (also 55) of fiber 40 merges with optical axis 55 of endcap 50 or may at least be parallel to optical axis 55. In order to achieve such parallelism, optical fiber may be spliced such that its optical axis is perpendicular to the plan of the back end 51.

In some embodiments, all optical fibers 40 are aligned at the same polarization. For example, a mark may be made on one side face 54 of endcap 50 making the polarization of the fiber. Therefore, all endcaps 50 should be glued such that all the marker are at the same orientation, ensuring uniform polarization of the fibers in the array.

In some embodiments, each endcap 50 may include a front lens 52 at a front end 53 of endcap 50, as illustrated in FIGS. 1A and 1C, which is an illustration of a hexagonal endcap with a lens. In some embodiments, the optical profile of each lens 52 may be determined to form a Gaussian beam. In some embodiments, the optical profile of each lens 52 may be determined to form a desired profile (e.g., super-Gaussian beam, top hat beam, etc.) at the output faces of the system. In some embodiments, lens 52 may be a spheric lens or aspheric lens, for example, in a super-Gaussian beam.

In some embodiments, length ‘L’ may be determined in order to reduce the power density and therefore, make the endcap front facet 53/52 be less sensitive to contaminations.

In some embodiments, each endcap 50 may include a planner front end 53, substantially perpendicular to the optical axis of endcap 50, as illustrated in FIGS. 1A and 1D, which is an illustration of an endcap with a flat front end. As illustrated in FIG. 1D, light 11 reflected back from flat surface 53 is diverged on the surface of back end 51.

In some embodiments, the length ‘L’ of each endcap 50 is determined based on the wavelength, the numerical aperture (NA) of fiber 40, and a desired beam diameter D, for example, using equation 1.

$$L = \frac{D}{NA} \qquad ( 1 )$$

In some embodiments, the NA is proportional to the beam's wavelength and inversely proportional to fiber 40 core diameter.

In some embodiments, a diameter of the circumscribed circle of each endcap (for example, a hexagonal endcap, a quadrangular endcap or endcaps having any other polygonal cross sections) is determined based on the desired beam diameter and internal reflectance inside the endcap.

The length ‘L’ is optimized such that from a surface 25 of DOE (Diffractive Optical Element) 20, a uniform collimated beam 15 is formed having maximum energy with no overlapping and no gaps between the collimated beams 10.

Reference is now made to FIG. 1E which is an illustration of the reflected light from the surface of the lens back into the endcap, according to some embodiments of the invention. In some embodiments, when the focal length fₗₑₙₛ of lens 52 which is as equal to L the length of endcap 50, light reflected back from lens 52 will scatter, as illustrated. Therefore, the diameter of the reflected beam is wider than the diameter of the beam entering encamp 50 from fiber 40. Accordingly, no damage to the fiber/endcap interface will occur.

The focal length fₗₑₙₛ of lens 52 may be determined using equations 2a and 2b:

$${f}_{lens} = {ROC}_{lens} / Δ n \qquad ( 2 a )$$

$${f}_{lens} = 2 \cdot {ROC}_{lens} \qquad ( 2 b )$$

When Δn=n_{glass}−nₐᵢᵣ≈0.5 is the difference between the reflective indexes of glass and air and ROC is the radius of curvature of lens 52.

In some embodiments, the focal point of lens 52 may be determined based on the determined length ‘L’. In some embodiments, the length of the endcaps is substantially similar but shorter to the focal length of lens 52, to avoid focusing the return light into the fiber.

In some embodiments, the dimensions of endcaps 50 are determined to minimize thermal effects, for example, heat accumulation due to reflectance, the passage of light from one endcap to a neighboring endcap via the endcap's side faces 54, and the like. Light 11 may be guided as to exit endcaps 50, from back end 51. In some embodiments, in order to eliminate the light passing between neighboring endcaps, side facets 54 of each endcap 50 are coated with antireflective coating. Some nonlimiting examples for antireflective coating may include, nanostructure forming, monolayer ion deposition, volatilization and the like.

In some embodiments, optical fiber 40 may be made from an optical glass. In some embodiments, the diameter of optical fiber 40 core is between 5 to 50 μm, for example, between 5 to 20 μm, 10 to 30 μm, 10 to 40 μm, 20 to 50 μm and any value or range in between.

In some embodiments, adhesive 60 gluing endcaps 50 to each other may be selected from a transparent adhesive, an optical adhesive, a transparent optical adhesive and the like.

In some embodiments, adhesive 60 material may further be selected to have a thermal coefficient (after hardening) which is as close as possible to the thermal coefficient of endcaps 50. The thermal coefficient is selected to minimize the formation of thermal stress on endcaps 50. Therefore, the thermal coefficient (CTE) of the adhesive material may be between 0.1 to 200 [ppm° C.] (and any value in between) and the optical absorption at the required wavelength of less than 5 ppm.

In some embodiments, the thickness of adhesive 60 is between 0.0001 to 0.1 of the diameter of the inscribed circle of the endcaps cross-section. For example, the thickness of adhesive 60 is between 0.0001 to 0.0005, 0.0005 to 0.001, 0.001 to 0.005, 0.005 to 0.01, 0.01 to 0.05, 0.05 to 0.1 and any value or range in between.

In some embodiments, adhesive 60 may cover at least 50% of the surface between each two side-faces 45 attached to each other. For example, adhesive 60 may cover at least 50%, at least 55%, at least 60%, at least 65%, at least 70%, at least 75%, at least 80%, at least 85%, at least 90%, at least 95% or 100% and any value in between.

In some embodiments, adhesive 60 may further include small spherical particles of a uniform diameter, that may be added to ensure forming a uniform thickness of adhesive 60. The diameter of the small spherical particles may vary between 0.0001 to 0.1 of the diameter of the inscribed circle of the endcaps cross-section. In some embodiments, the small spherical particles may include glass, fused silica, alumina, or any other ceramic material.

Reference is now made to FIGS. 2A and 2B which are illustrations of perspective views of two tiled collimator arrays comprising hexagonal endcaps according to some embodiments of the invention. Tiled collimator arrays 200 or 250 may include substantially the same hexagonal endcaps 50, optical fibers 40, and adhesive 60 as tiled collimator array 100. In some embodiments, hexagonal endcaps 50 of collimator arrays 200 or 250 may or may not include a front lens. In the nonlimiting example of FIG. 2A, tiled collimator array 200 may include a plurality of hexagonal endcaps 50 staked in a 3 layers compacted structure. In the nonlimiting example of FIG. 2B, tiled collimator array 250 may include a plurality of hexagonal endcaps 50 staked in a substantially rectangular compacted structure.

Reference is now made to FIG. 3 which is an illustration of a perspective view of a tiled collimator array comprising quadrangular endcaps according to some embodiments of the invention. A tiled collimator array 300 may include a plurality of quadrangular endcaps 150 each being connected to an optical fiber 40 at a back end 151; and an adhesive 60 gluing endcaps 150 to each other.

In some embodiments, back end 151 of endcap 150 may be a plane perpendicular to the longitudinal axis of endcap 150. In some embodiments, the perpendicularity may vary between 0 to 0.5. In some embodiments, optical fiber 40 is spliced to back end 151 such that the optical axis of fiber 40 merges with the optical axis of endcap 150 or may at least be parallel to the optical axis. In order to achieve such parallelism, optical fiber 40 may be spliced such that its optical axis is perpendicular to the plan of the back end 151.

In some embodiments, each endcap 150 may include a front lens (not illustrated) at a front end 153 of endcap 150. In some embodiments, the front lens may be substantially the same as front lens 52 of endcap 50.

In some embodiments, the length ‘L’ of endcaps 150 may be determined similarly to determining the length ‘L’ of endcaps 50 discussed herein above.

In some embodiments, a diameter of a circumscribed circle of each endcap 150 is determined based on the desired beam diameter and internal reflectance inside the endcap.

In some embodiments, the dimensions of endcaps 150 are determined to minimize thermal effects, for example, heat accumulation due to reflectance, passage of light from one endcap to a neighboring endcap via the endcap's side faces and the like.

In some embodiments, tiled collimator arrays 100, 200, 250, or 300 may include or may be optically connected to additional optical components. For example, the additional optical components may include Diffractive Optical Elements (DOE) 20, illustrated in FIG. 1B, located ahead of front lenses 52 on an optical axis of the tiled collimator array. In some embodiments, the DOE may include wave front shaping element having face 25 configured to collimate beams 10 to form beam 15 at a plane 25 next to array 100, 200, 250, or 300. In some embodiments, the additional optical components may include spheric and aspheric surfaces (e.g., lenses), optical wedges and the like.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A tiled collimator array, comprising:
a plurality of endcaps each being connected to an optical fiber at a back end, wherein the endcaps are selected from hexagonal endcaps and quadrangular endcaps; and
an adhesive gluing the endcaps to each other,
wherein the endcaps are stacked together in a compacted structure.

2. The tiled collimator array of claim 1, wherein the adhesive is selected from, a transparent adhesive, and optical adhesive.

3. The tiled collimator array of claim 1, wherein a thickness of the adhesive is between 0.0001 to 0.1 of a diameter of the inscribed circle of the endcaps cross-section.

4. The tiled collimator array of claim 3, wherein the optical fiber is spliced to the back end such that the optical axis of the fiber merges with the optical axis of the endcap.

5. The tiled collimator array of claim 1, wherein each endcap comprises a front lens at a second end.

6. The tiled collimator array of claim 5, further comprising Diffractive Optical Elements (DOE) located ahead of the front lenses on an optical axis of the tiled collimator array.

7. The tiled collimator array of claim 5, wherein the length of the endcaps is equal to or shorter than the focal length of the lens.

8. The tiled collimator array of claim 1, wherein all the optical fibers are aligned at the same polarization.

9. The tiled collimator array of claim 1, wherein a length of each endcap is determined based on the wavelength, the numerical aperture (NA) of the fiber, and a desired beam diameter.

10. The tiled collimator array of claim 1, wherein a diameter of circumscribed circle of each endcap is determined based on the desired beam diameter and internal reflectance inside the endcap.

11. The tiled collimator array of claim 1, wherein a diameter of the optical fiber core is between 5 to 50 μm.

12. The tiled collimator array of claim 1, wherein side facets of each endcap are coated with antireflective coating.

13.-18. (canceled)
